(19) United States
(12) Patent Application Publication
(10) Pub. No.: US 2026/0328170 A1
(43) Pub. Date: Oct. 22, 2026

(54) SYSTEM AND METHOD FOR REDUCING EMISSIONS AND ENHANCING COMBUSTION USING OPTIONAL CERAMIC PLATES WITH CORONAL DISCHARGE FOR MOLECULAR REFORMATION

(71) Applicants: Joseph Carpenter, Byhalia, MS (US); Brian Albers, Greenville, SC (US)

(72) Inventors: Joseph Carpenter, Byhalia, MS (US); Brian Albers, Greenville, SC (US)

(21) Appl. No.: 19/649,233

(22) Filed: Apr. 16, 2026

Related U.S. Application Data
(60) Provisional application No. 63/790,223, filed on Apr. 17, 2025.

(51) Int. Cl. F02M 27/04; F01N 3/08

(52) U.S. Cl. CPC F02M 27/042; F01N 3/08; F01N 2240/28; F01N 2270/10

(57) ABSTRACT

A modular system and method for reducing emissions and enhancing combustion employ a fan to provide external air and application-specific ceramic plates over which the air passes. The system is configurable as intake-only, combined intake-and-exhaust, exhaust-only, or standalone, and the ceramic plates perform coronal discharge to reform air molecules via non-thermal plasma without relying on catalytic layers or producing hydrogen for fuel cells. The system reduces EPA-regulated emissions including CO, NOx, HC, PM, and CO2, and in exhaust configurations increases vehicle tailpipe oxygen to a normal atmospheric level of approximately 20-22% by volume. Plate composition, size, and quantity are selectable and adjustable based on application requirements and desired emission reduction levels. The system is powered by an external 12V DC or 110V AC power supply and may be further enhanced by fan integration to amplify plasma interaction and gas mixing. No thermal plasma or combustion-based treatment is employed.

### CROSS-REFERENCE TO RELATED APPLICATIONS

This application claims priority to and the benefit of U.S. Provisional Patent Application No. 63/790,223, filed Apr. 17, 2025, the entire contents of which are incorporated herein by reference in their entirety.

### FIELD OF THE INVENTION

The present invention relates generally to emission reduction and combustion enhancement systems, and more particularly to modular systems and methods employing non-thermal plasma generated by coronal discharge through ceramic plates to reform air molecules in intake air streams, exhaust gas streams, or both, for fuel-burning engines and industrial exhaust applications.

### BACKGROUND OF THE DISCLOSURE

Vehicle exhaust emissions—for example, carbon monoxide (CO), nitrogen oxides (NOx), hydrocarbons (HC), particulate matter (PM), and carbon dioxide (CO2)—are regulated by the Environmental Protection Agency (EPA) due to their environmental impact. Existing solutions, such as catalytic converters, use high-temperature oxidation and reduction with precious metal catalysts (e.g., platinum, rhodium) to convert CO, NOx, and HC into CO2, N2, and H2O. However, these systems do not address comprehensive emission reduction across all EPA-regulated pollutants, including CO2, nor do they increase tailpipe oxygen to match normal atmospheric levels (20-22%). Systems using catalytic reformation for hydrogen production focus on fuel cell applications, not broad emission reduction or oxygen enhancement.

Still further, fuel-burning systems, such as internal combustion engines (ICEs) and industrial exhaust systems, produce emissions including NOx, CO, HC, and CO2, which are regulated under EPA standards aimed at mitigating air pollution and climate change. Stationary industrial sources, including manufacturing facilities, paint booths, and agricultural operations, produce localized concentrations of VOCs, PM, NOx, and CO that are not addressed by vehicle-centric emission control technologies, and for which no modular non-thermal plasma treatment solution currently exists.

Existing technologies, such as catalytic converters, intake air treatment systems, and plasma-based exhaust processors, address some emissions but lack modularity to apply coronal discharge to intake air, exhaust pipes, or both across diverse fuel-burning and industrial applications, while reducing all EPA-regulated gaseous emissions, increasing gas mileage or oxygen output, and elevating exhaust oxygen to atmospheric levels using non-thermal plasma powered by an external electric source, with enhanced effects achievable through fan integration.

Conventional exhaust resonators, which smooth exhaust pulsation and reduce acoustic noise, are commonly positioned between the catalytic converter and the exhaust outlet; however, these components do not contribute to molecular reformation, emission reduction, or oxygen enrichment of the exhaust stream.

A need exists for a flexible, modular system that reduces all EPA-regulated emissions through molecular reformation via coronal discharge, increases tailpipe O2 to atmospheric levels in exhaust configurations, and enhances combustion by providing cleaner intake air. Such a system should be adaptable to intake-only, intake-and-exhaust, exhaust-only, or standalone applications without requiring catalytic materials, hydrogen generation, or thermal plasma processes. Prior-art plasma-based exhaust treatment systems process exhaust gases in isolation, without the simultaneous introduction of external ambient air. No existing system achieves a tailpipe oxygen concentration matching normal atmospheric levels (20-22% by volume) through the combination of externally supplied fan-driven air, non-thermal plasma molecular reformation, and downstream mixing of treated air with exhaust gases. The absence of this approach leaves a gap in both emission reduction completeness and exhaust oxygen enrichment.

### SUMMARY OF THE DISCLOSURE

The present disclosure is directed in general to systems and related methods for reducing emissions and enhancing combustion using a variety of plates for molecular reformation via coronal discharge. The systems are modular for use with any fuel-burning system or industrial exhaust system, and may be deployed without modification to existing catalytic converters or engine management systems.

In one embodiment, a system includes a fan to provide external air and ceramic plates over which the air passes, the plates being optional and selected based on the needs of the application and environment. The exemplary system may be configured as: (a) “Intake Only”—with plates to reform intake air to provide cleaner air for improved combustion; (b) “Intake and Exhaust”—with plates to treat both intake air and exhaust gases, thereby reducing emissions and increasing tailpipe O2; (c) “Exhaust Only”—with plates to treat exhaust gases and mix with external air to reduce emissions and increase tailpipe O2; and (d) “Standalone”—with plates to treat atmospheric air for standalone emission reduction in industrial or stationary applications.

In some embodiments, ceramic plates are selected from non-ozone ceramic plates, silicon carbide plates, ceramic fiber plates, and—for specific applications such as temporary testing—generic coronal field generator plates. The selected plates perform coronal discharge to reform air molecules without relying on catalytic layers or producing hydrogen for fuel cells. The system reduces all EPA-regulated emissions (CO, NOx, HC, PM, CO2) and, in exhaust configurations, increases tailpipe oxygen to the normal atmospheric level of 20-22%, matching outside air. The system can use a 12V or 110V power supply depending on application needs.

In a further embodiment, a modular coronal discharge system configured for use with fuel-burning systems and industrial exhaust systems may include an Intake Configuration having a coronal unit that ionizes incoming air using non-thermal plasma generated by ceramic plates of adjustable size to enhance oxygen content and improve combustion efficiency.

In another embodiment, a modular coronal discharge system configured for use with fuel-burning systems and industrial exhaust systems may include an Exhaust Pipe Configuration having a coronal unit that processes exhaust gases at the exhaust pipe, downstream of a catalytic converter when one is present in the exhaust system, or directly at the exhaust pipe in vehicles or systems not equipped with a catalytic converter in engines, using non-thermal plasma to dissociate water vapor and carbon dioxide, producing an oxygen-enriched exhaust with oxygen levels increased from normal exhaust levels to normal atmospheric levels at a temperature equal to or below ambient levels. The Exhaust Pipe Configuration reduces all gaseous emissions regulated by EPA standards while increasing gas mileage in engines or oxygen output in industrial systems, with effects amplifiable by a fan.

In yet another embodiment, a modular coronal discharge system may include a Dual Configuration that combines intake and exhaust pipe units for maximum emissions reduction, using either separate coronal units or a single set of ceramic plates for both intake and exhaust.

In still another embodiment, a modular coronal discharge system may include a Power System having an external electric power source that supplies energy to drive coronal discharge units, selectable between 12V DC and 110V AC depending on application requirements.

In certain embodiments, an optional electronic control unit (ECU) is operatively connected to the power supply and fan to dynamically adjust plasma discharge parameters and fan speed based on detected exhaust conditions, system load, or selected operational mode.

The plate sizes of the various embodiments and their equivalents are easily adaptable based on a desired level of emissions reduction and to avoid thermal plasma or combustion-based exhaust treatment.

Exemplary methods of operation may include an Intake Mode in which Intake air passes through a coronal discharge unit, where a non-thermal plasma, powered by an external electric power source, ionizes the air to enhance its oxygen content, improving combustion efficiency and increasing gas mileage in engines or enhancing fuel-burning processes in industrial systems, with effects amplifiable by a fan to improve air flow through the plasma field. Alternatively, in an Exhaust Pipe Mode exhaust gases may enter a coronal discharge unit at an exhaust pipe, where a non-thermal plasma, powered by an external electric power source, dissociates water vapor and carbon dioxide, producing an oxygen-enriched exhaust with oxygen levels increased from normal exhaust levels to normal atmospheric levels at a temperature equal to or below ambient levels, reducing gaseous emissions regulated by EPA standards while contributing to increased gas mileage in engines or oxygen output in industrial systems, with effects amplifiable by a fan to enhance gas mixing and plasma interaction. And in a Dual Mode intake air is ionized by a coronal unit, followed by exhaust gas treatment at the exhaust pipe by another coronal unit—or a single set of ceramic plates serving both—both powered by an external electric power source, maximizing emissions reduction and gas mileage or oxygen output through combined combustion enhancement and exhaust processing, with effects amplifiable by fans at one or both stages.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which refers to the appended figures, wherein:

FIG. 1 is a schematic diagram of a modular coronal system according to an aspect of the disclosure in a dual intake-and-exhaust configuration, showing a fan for providing external air, ceramic plates, a mixing mechanism for exhaust, an air intake system with plates, and an external power source;

FIG. 2 is a schematic diagram of a modular coronal system similar to FIG. 1 but in an intake-only configuration;

FIG. 3 is a schematic diagram of a modular coronal system similar to FIG. 1 in an exhaust pipe-only configuration, also showing additional intake fans;

FIG. 4 is a perspective view of a coronal unit with adjustable ceramic plates, plasma field, and an external power connection;

FIG. 5 is a perspective view of a plate set configuration showing two ceramic shared plates connected to a power supply for use with both intake and exhaust; and

FIG. 6 is a perspective view of an intake and/or exhaust pipe application with fan enhancement as depicted in FIG. 3, particularly showing a coronal unit and a mixing chamber in an intended use environment.

### DETAILED DESCRIPTION OF THE DISCLOSURE

As required, detailed embodiments are disclosed herein; however, the disclosed embodiments are merely examples and may be embodied in various and alternative forms. Therefore, specific structural and functional details disclosed herein are not to be interpreted as limiting, but merely as a basis for the claims and as a representative basis for teaching one skilled in the art to variously employ the exemplary embodiments of the present disclosure, as well as equivalents thereof.

Unless defined otherwise, all technical, engineering, and scientific terms used herein have the same meaning as is commonly understood by one of ordinary skill in the art to which this disclosure belongs. In the event of a plurality of definitions for a term, phrase, or acronym, those in this section prevail unless stated otherwise.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and/or measurement conditions for such given value. “Class 1, Division 2” relates to hazardous environments or locations as defined in Section 1910.307 of OSHA regulations.

The term “ranges” includes all combinations of sub-ranges. For instance, a range from 100-200 includes ranges such as 110 to 150, 170 to 190, and 153 to 162. Similarly, “limits” means all sub-limit combinations; e.g., a limit of up to 7 also includes limits of up to 5, up to 3, and up to 4.5.

The terms “comprising,” “including,” “having,” and “involving” (and similarly “comprises,” “includes,” “has,” and “involves”) and the like are used interchangeably and have the same meaning. Each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, a phrase such as: “a method involving a, b, and c” means that the method includes at least steps a, b, and c.

Where a list of alternative component terms is used, e.g., “a structure such as ‘a,’ ‘b,’ ‘c,’ ‘d’ or the like,” or “a or b,” such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

While specific numerical parameters are disclosed herein (e.g., tailpipe O2 of 20-22%, byproduct formation below 0.05 ppm, fan flow rate of 200 CFM), these values are exemplary and non-limiting. Actual performance will vary depending on engine type, fuel composition, ambient conditions, exhaust flow rate, ceramic plate type and quantity, and power supply characteristics. No warranty, express or implied, is made with respect to the achievement of any specific performance metric in any particular application. The present disclosure does not constitute a representation that all embodiments will achieve each stated parameter under all conditions.

The systems and methods described herein are intended to assist in the reduction of vehicle and industrial emissions. However, compliance with applicable federal, state, and local emissions regulations—including but not limited to EPA standards under the Clean Air Act—is the sole responsibility of the manufacturer, installer, and/or end user. The present disclosure does not guarantee regulatory compliance, and independent testing in accordance with applicable standards (e.g., EPA TP-2003-01, FTP-75 driving cycle) is recommended before commercial deployment.

Systems as disclosed herein, available under the trademark CleanER Air™, broadly include fans for providing external air that optionally passes over ceramic plates, configurable as intake only, intake and exhaust, exhaust only, or standalone, which effect coronal discharge reformation and a specific O2 target. More specifically, the systems reduce EPA-regulated emissions (CO, NOx, HC, PM, CO2) and, in exhaust configurations, increase tailpipe O2 to the normal atmospheric level of 20-22%, matching outside air. The plates perform coronal discharge for molecular reformation and are optionally selected based on specific application and environmental needs. The system can use a 12V or 110V power supply, also depending on applicational needs.

The system as disclosed in present invention operates in four configurations, each following a distinct gas flow path. In the Intake-Only configuration, external air enters via fan, passes optionally through air filter, flows over or between ceramic plates where non-thermal plasma is generated by power supply, and the oxygen-enriched treated air proceeds into air intake system upstream of the engine combustion chamber. In the Exhaust-Only configuration, external air from fan passes over plates and the resulting treated air is combined in mixing mechanism (e.g., a Y-pipe) with exhaust gases that have traveled from engine through the catalytic converter and resonator before reaching the mixing mechanism; the combined oxygen-enriched stream exits at tailpipe area. In the Dual configuration, both the Intake-Only and Exhaust-Only flow paths are active simultaneously, each powered by external electric power source. In the Standalone configuration, external air is drawn by fan over plates for atmospheric air treatment in industrial or stationary settings, with treated air discharged to the environment. In all configurations, the ceramic plates and their associated power supply are optional; the fan alone may serve to dilute exhaust or enhance intake air when plates are omitted.

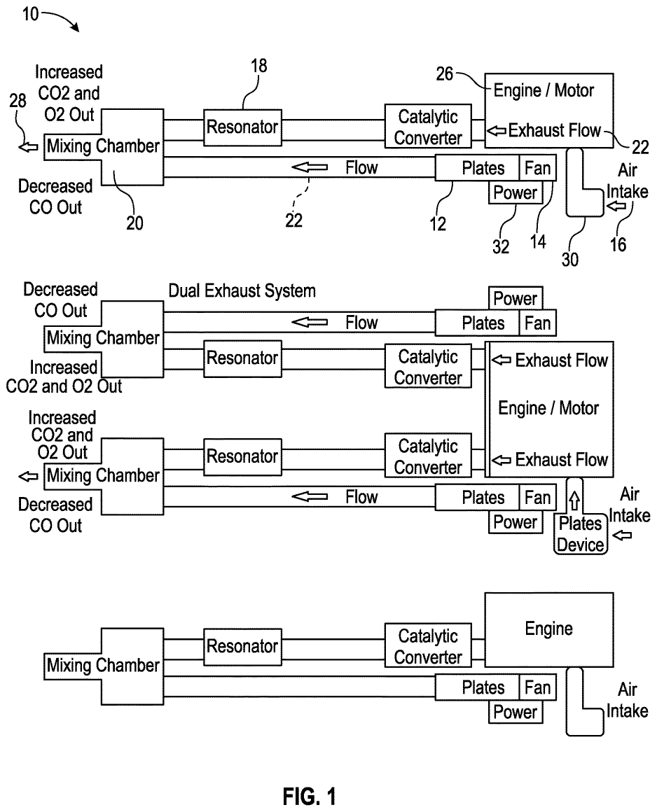

Turning now to FIG. 1, a CleanER™ Air system broadly indicated by reference numeral 10 reduces emissions and enhances combustion using one or more optional ceramic plates 12 for molecular reformation via coronal discharge. More particularly, the system 10 includes a fan 14 (e.g., 200 CFM, 150 W) to provide external air 16 (approximately 20-22% O2, matching normal atmospheric levels, 20-50 °C) that passes over the plates 12 (e.g., 4″×2″×0.5″ ceramic plates) to perform coronal discharge and reform air molecules without relying on catalytic layers or producing hydrogen for fuel cells. The composition of the plates 12 is selected based on specific applications and environmental needs and requirements (e.g., diesel vehicles in urban settings with high PM may use silicon carbide plates, while gasoline vehicles in rural settings may use non-ozone ceramic plates). The plates 12 can be omitted if a specific application and environment do not require their use and rely solely on the external air 16 from the fan 14 to dilute exhaust emissions in exhaust configurations or enhance intake air within intake configurations.

As further shown in FIG. 1, a mixing mechanism or chamber 20 may be provided in an Exhaust Configuration. In exhaust-only or intake-and-exhaust configurations, the mechanism 20 (e.g., a Y-pipe) mixes treated air 22 with exhaust gases 24 from an engine 26, directing the mixture to a tailpipe, generally depicted at area 28. In intake-only or intake-and-exhaust configurations, the ceramic plates 12 may be placed in an air intake system 30 where the external air 16 passes over the plates 12 before entering the combustion chamber to improve air quality for cleaner combustion. In standalone applications, the system 10 treats atmospheric air 16 for emission reduction (e.g., industrial or stationary use).

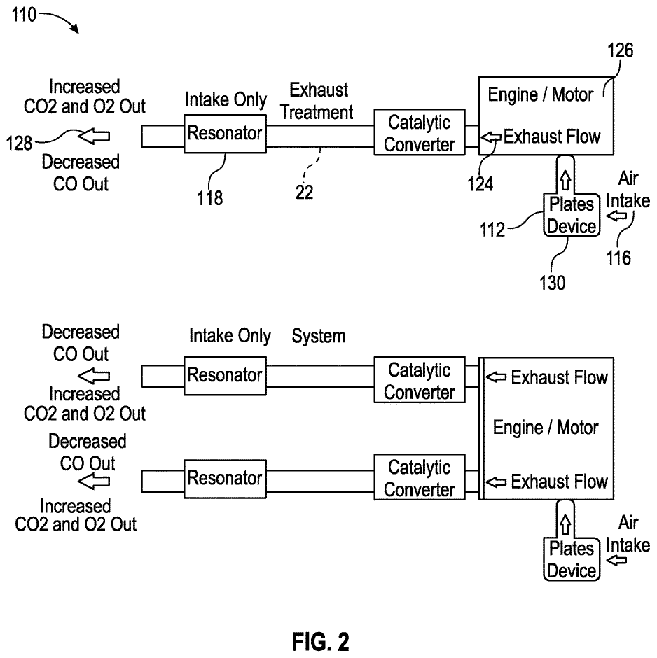

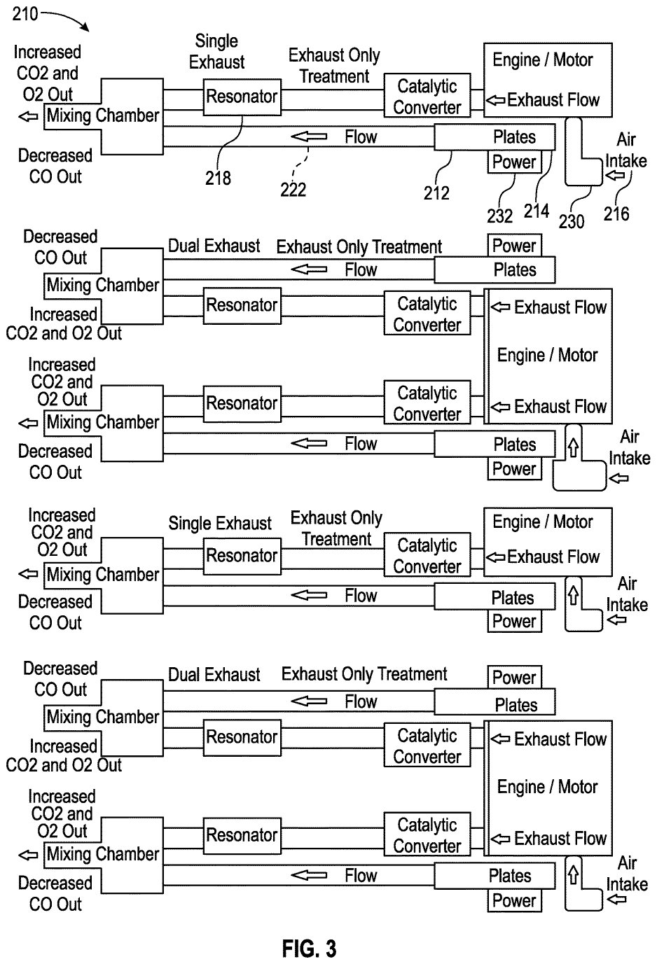

Also shown in FIG. 1, a resonator 18 is positioned in the exhaust flow path downstream of the catalytic converter and upstream of the mixing mechanism 20. The resonator 18 is a conventional exhaust resonator configured to smooth exhaust gas pulsation, reduce acoustic noise, and stabilize exhaust flow velocity prior to entry into the mixing mechanism 20. The resonator 18 is a pre-existing component of the host exhaust system and does not itself perform coronal discharge, molecular reformation, or emission reduction; its inclusion in the figures is for contextual accuracy. In intake-only or standalone configurations, the resonator 18 is not part of the gas flow path for the coronal discharge system. Corresponding resonators 118 and 218 are shown in FIGS. 2 and 3, respectively, and perform equivalent functions in those configurations.

FIG. 1 further shows a 12V or 110V power supply 32 (e.g., 12V DC to 24 kV DC converter for automotive use, or 110V AC for standalone or industrial applications) to power coronal discharge when plates 12 are used, again depending on specific applications. An optional electronic control unit (ECU) may be operatively connected to the power supply 32 and fan 14 to dynamically regulate plasma discharge intensity and fan speed based on real-time exhaust conditions or engine load; the ECU is described in further detail below.

With more particular reference to the plates 12, the plates 12 may be Non-Ozone Ceramic Plates made from high-dielectric ceramic (e.g., zirconia, dielectric constant ~20-30) with titanium mesh electrodes (work function 4.33 eV, reducing unwanted byproducts). The plates 12 are optimized for molecular reformation via coronal discharge (e.g., 10 kV, 10-15 ns rise time) with minimal byproduct formation (<0.05 ppm) to reform air molecules (e.g., O2, N2) and pollutants (e.g., 2NO→N2+O2, CO2→CO+½O2), reducing CO, HC, NOx, CO2, and PM via electrostatic effects. In exhaust configurations, O2 is increased by the plates 12 through reformation to achieve tailpipe O2 of 20-22%, matching outside air. In intake configurations, the plates 12 reform intake air to increase O2 content and reduce contaminants (e.g., VOCs), improving combustion efficiency. In standalone configurations, the plates 12 treat atmospheric air for emission reduction.

The plates 12 also may be Silicon Carbide Plates made from silicon carbide (SiC, melting point 2700 °C) with titanium electrodes, designed for high PM capture. The Silicon Carbide Plates 12 combine reformation with PM filtration via coronal discharge (e.g., 10 kV), producing minimal byproducts (tunable to <0.05 ppm), and reform air molecules into O2 (e.g., NOx, CO2 breakdown), achieving tailpipe O2 of 20-22% in exhaust configurations with sufficient fan airflow (e.g., 200 CFM). These plates 12 further reduce CO, HC, NOx, CO2, and PM, with high effectiveness for PM-heavy exhaust. The Silicon Carbide Plates 12 are preferred for diesel vehicles in urban settings with high PM emissions.

The plates 12 also may be Ceramic Fiber Plates made from fibrous ceramic (e.g., alumina-silica fibers, stable to 1200 °C) with titanium electrodes for moderate PM capture. The Ceramic Fiber Plates 12 effect similar reformation to silicon carbide plates via coronal discharge, with minimal byproducts (tunable to <0.05 ppm), and increase O2 through reformation (tailpipe O2: 20-22% in exhaust configurations). These plates 12 are most suitable for vehicles in mixed environments (e.g., suburban settings), balancing PM capture and molecular reformation.

The plates 12 include generic Coronal Field Generator plates made from high-dielectric ceramic (e.g., alumina, dielectric constant ~9-10) with stainless steel mesh electrodes (50% open area, 0.02″ wire diameter). The Coronal Field Generator plates 12 effect enhanced coronal discharge (12-24 kV, 10-20 ns rise time, 50-200 ns pulse length) to reform air molecules, focusing on CO and HC reduction (e.g., CO→CO2). In exhaust configurations, Coronal Field Generator plates may lower tailpipe O2 below the target 20-22% due to the nature of the discharge process. These plates 12 are best suited for specific applications, such as temporary testing, where enhanced coronal discharge is prioritized.

In summary, the system 10 and its plates 12 reduce EPA-regulated emissions (CO, NOx, HC, PM, CO2) as follows: Non-Ozone Ceramic Plates reduce CO, HC, NOx, CO2 (via reformation: CO2→CO+½O2), and PM (via electrostatic effects); Silicon Carbide Plates reduce CO, HC, NOx, CO2, and PM with high effectiveness for PM capture, making them ideal for diesel vehicles; Ceramic Fiber Plates reduce CO, HC, NOx, CO2, and PM with moderate PM capture, balancing effectiveness across pollutants; and Generic Coronal Field Generator Plates reduce CO and HC through enhanced coronal discharge, but have limited effect on NOx, PM, and CO2.

In exhaust-only or intake-and-exhaust configurations, the system 10 and its plates 12 increase tailpipe oxygen to the normal atmospheric level of 20-22% through a combination of fan air dilution (e.g., 200 CFM, 20-22% O2) and molecular reformation (e.g., NOx→N2+O2, CO2→CO+½O2). The system 10 is tunable to <0.05 ppm for all plates except Generic Coronal Field Generator Plates.

In intake-only or intake-and-exhaust configurations, optional plates 12 increase O2 content (e.g., 20-22%) and reduce contaminants (e.g., VOCs, PM), improving combustion efficiency and further reducing emissions.

In standalone applications, the system 10 treats atmospheric air, reducing emissions (e.g., VOCs, PM) with effectiveness depending on the selected plates 12.

With reference to FIG. 2, a modular coronal system 110 similar to FIG. 1 is shown in an intake-only configuration with plates 112 made, e.g., from ceramic material, effecting coronal discharge and molecular reformation. Here, a treated air mixture 122 may be effected by the ceramic plates 112 that are placed in an air intake system 130 to treat intake air 124 from an engine 126, which directs the treated mixture toward a tailpipe, generally depicted at area 128.

FIG. 3 shows another modular coronal system 210 similar to FIG. 1 in an exhaust pipe-only configuration, particularly showing plates 212 arranged with intake fans 214 and a power supply 232 apart from an air intake system 230. The system 210 provides treated air 222 with decreased CO and increased O2.

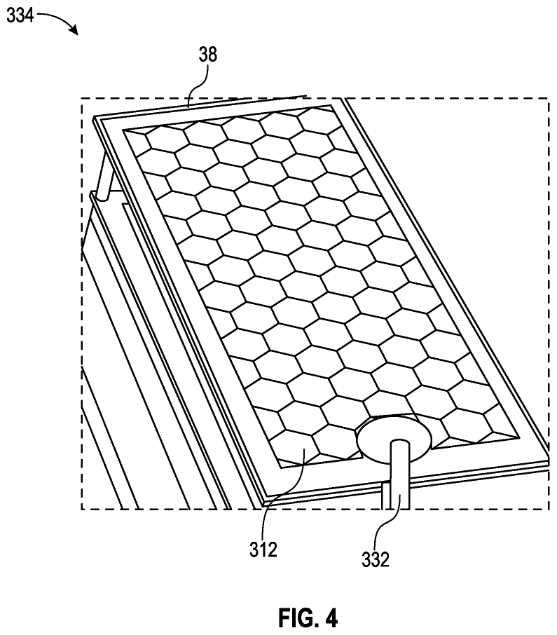

FIG. 4 is a perspective view of a coronal unit 334 with adjustable ceramic plates 312 with an external power connection 332 for providing a plasma field that may be used with various embodiments as shown and described herein and their equivalents.

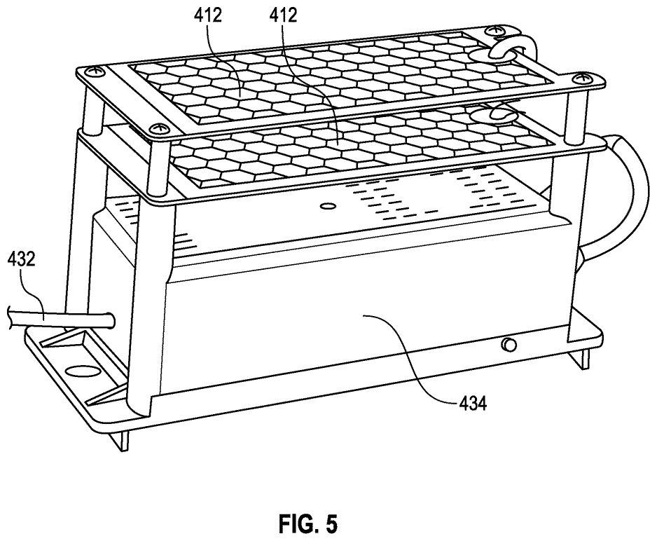

FIG. 5 is a perspective view of a plate set configuration 434 with two shared ceramic plates 412 connected to a power supply 432 for use with both intake and exhaust, that may be used with various embodiments as shown and described herein and their equivalents.

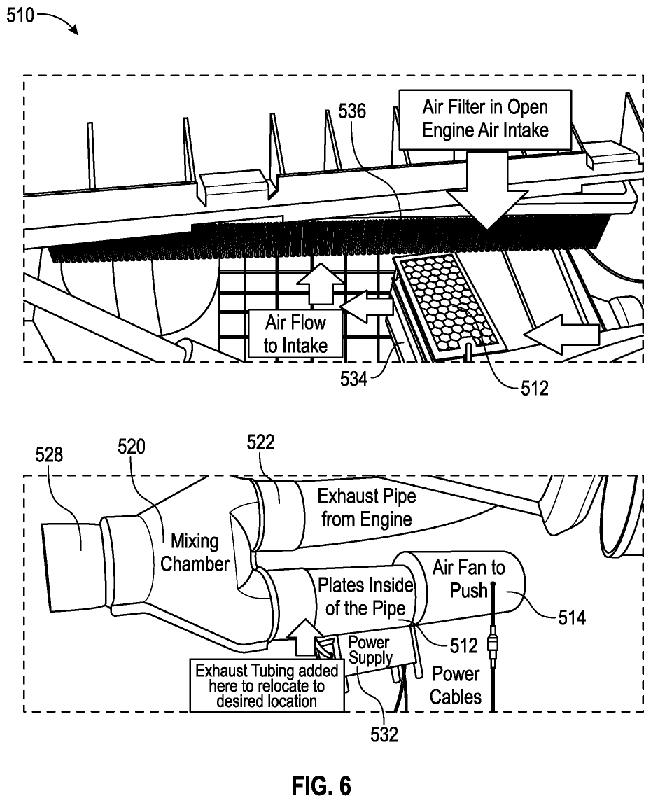

FIG. 6 shows an intake and/or exhaust pipe system 510 with fan enhancement 514, a mixing chamber 520, a power supply 532, and a coronal unit 534 installed in an intended use environment. The system 510 reduces emissions and enhances combustion using plates 512 for molecular reformation via coronal discharge. More particularly, the system 510 may receive external air 516 that passes over the plates 512, through an air filter 536, and is mixed with pipe exhaust 522 in the mechanism 520 (e.g., a Y-pipe).

In the configuration shown in FIG. 6, the Coronal Discharge Unit 534 may include multiple ceramic plates 512 (e.g., alumina), optionally coated with a catalyst (e.g., titanium dioxide), arranged in a housing with adjustable plate sizes and quantities tailored to the application and desired emissions reduction. Each pair of plates is configured with opposing electrical charges (positive/negative). A single set of ceramic plates may be used for both intake and exhaust, or separate sets may be employed for each.

By way of exemplary operation, the system 510 generates a non-thermal plasma via pulsed coronal discharge, powered by the external electric power source 532, to ionize gases, enhance oxygen content in intake air 516, or dissociate water vapor and carbon dioxide in exhaust gases to produce an oxygen-enriched output with oxygen levels increased from normal exhaust levels to normal atmospheric levels, reducing all gaseous emissions regulated by EPA standards while increasing gas mileage in engines or oxygen output in industrial systems. The effects are amplifiable by the fan 514 to enhance gas flow and plasma interaction. Further, the system 510 is adaptable, adjustable, and modular, as plate sizes and numbers are configurable to scale the plasma field intensity, accommodating varying system sizes, exhaust flows, or reduction targets.

In an Intake Configuration, the system 510 will ionize intake air 516 to enhance its oxygen content, improve combustion efficiency, and increase gas mileage in engines or enhance fuel-burning processes in industrial systems, with effects amplifiable by the fan 514 to optimize air circulation through the plasma field. The increase in reactive oxygen content of intake air achieved by coronal discharge ionization promotes more complete oxidation of the air-fuel mixture within the combustion chamber, reducing the proportion of unburned hydrocarbons and extracting greater mechanical energy per unit of fuel consumed, thereby increasing fuel economy as measured in miles per gallon (MPG) or equivalent fuel consumption metrics in internal combustion engine applications.

In an Exhaust Pipe Configuration, the system 510 in FIG. 6 will process exhaust gases at an exhaust pipe 528, downstream of a catalytic converter when one is present in the exhaust system, or directly at the exhaust pipe in vehicles or systems not equipped with a catalytic converter in engines to dissociate water vapor and carbon dioxide, producing an oxygen-enriched exhaust with oxygen levels increased from normal exhaust levels to normal atmospheric levels at a temperature equal to or below ambient levels, reducing gaseous emissions regulated by EPA standards, including nitrogen oxides, carbon monoxide, hydrocarbons, and carbon dioxide, while contributing to increased gas mileage in engines or oxygen output in industrial systems, with effects amplifiable by the fan 514 to enhance exhaust gas mixing and plasma efficiency.

More specifically, in the Exhaust Pipe Configuration the Coronal Discharge Unit 534 will be placed at or near an exhaust pipe 528, downstream of the combustion source or catalytic converter (if present) with an array of adjustable ceramic plates 512 with the optional fan 514 for gas mixing, sized to match exhaust flow and reduction needs. This arrangement assists with cooling as the non-thermal plasma absorbs or dissipates heat from the exhaust, maintaining an exit temperature at or below ambient conditions without external cooling.

In a Dual Configuration, the system 510 combines intake and exhaust pipe coronal units 534 for maximum emissions reduction and enhancement of combustion efficiency. The intake unit 534 is ideally positioned upstream of a combustion source and the exhaust unit 534 is placed at the exhaust pipe 528, downstream of a catalytic converter when one is present in the exhaust system, or directly at the exhaust pipe in vehicles or systems not equipped with a catalytic converter in engines. Independent or integrated housings with adaptable ceramic plates 512 may optionally be equipped with fans 514 for each stage, or a single set of plates 512 may serve both functions.

As briefly introduced above, the external electric power source 532 provides electrical energy to drive the coronal discharge units 534, delivering consistent power for plasma generation across all configurations. An electronic control unit (ECU) may be incorporated to adjust plasma operation and optional fan speed based on system load, exhaust conditions, or configuration (intake, exhaust pipe, or dual), optimizing performance.

Certain embodiments of the disclosed system may be deployed in environments containing flammable gases, vapors, or combustible dusts (e.g., paint booths, welding environments, and garages), classified as Class 1, Division 2 under OSHA Section 1910.307. Users deploying the system in such environments should ensure that all electrical components, power supplies, and enclosures comply with applicable hazardous location certifications (e.g., NEC Article 500, ATEX, or IECEx standards).

In certain configurations—particularly those deployed in environments containing flammable gases, vapors, or combustible dusts—the housing of the coronal discharge unit 334 may include a sealing ring or pressurization seal 38 disposed about the perimeter of the housing. The sealing ring 38 is configured to maintain a positive air pressure differential within the housing interior relative to the surrounding ambient environment, preventing the ingress of flammable ambient gases into the plasma generation zone and ensuring that the coronal discharge occurs only within the treated, controlled airstream supplied by the fan. The sealing ring 38 may be fabricated from a chemically resistant elastomeric material (e.g., silicone or fluorosilicone) compatible with hydrocarbon vapors and is dimensioned to seat against the housing perimeter and any inlet or outlet flanges of the unit. All electrical components within a housing equipped with the sealing ring 38 should be rated for the applicable hazardous location classification prior to deployment. The disclosure of a sealing ring or pressurization feature in certain embodiments does not constitute a certification for use in hazardous locations. Independent certification by a nationally recognized testing laboratory (NRTL) is recommended prior to deployment in any hazardous location.

The claimed coronal discharge mechanism and molecular reformation process are distinguishable from prior art catalytic converters in that no platinum-group or other precious-metal catalytic material is required for the primary emission reduction mechanism. The claimed system is further distinguishable from plasma-assisted fuel reformers in that the system does not produce hydrogen as an intended output for fuel cell use. Nothing in the present disclosure should be construed as an admission that any prior art reference constitutes prior art against any claim of this application.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

### EXEMPLARY EMBODIMENTS

### Embodiment 1: Base System

A system 10 for reducing emissions and enhancing combustion, the system comprising: a fan 14 configured to provide a flow of external air 16 at a flow rate sufficient to support molecular reformation and, in exhaust configurations, to achieve a tailpipe oxygen content of between about 20% and about 22% by volume when the treated airflow is mixed with exhaust gases; at least one ceramic plate 12 positioned within a housing such that the external air 16 passes over or between the at least one ceramic plate 12 during operation, the at least one ceramic plate 12 being selected from the group consisting of non-ozone ceramic plates, silicon carbide plates, ceramic fiber plates, and combinations thereof; a power supply 32 electrically connected to the at least one ceramic plate 12 and configured to apply a voltage sufficient to generate a coronal discharge across the at least one ceramic plate 12, producing a non-thermal plasma that reforms air molecules passing therethrough without relying on catalytic layers, precious-metal catalysts, or the production of hydrogen for fuel cell applications; and a housing configurable in at least one of the following operational modes: (i) an intake-only configuration in which the at least one ceramic plate 12 is positioned in or upstream of an air intake system 30 to treat incoming combustion air prior to its entry into a combustion chamber or intake manifold of an engine 26 or fuel-burning industrial system, thereby enhancing oxygen content and improving combustion efficiency; (ii) an exhaust-only configuration in which the at least one ceramic plate 12 is positioned at or proximate an exhaust pipe 28 to treat exhaust gases 24 exiting an engine 26 or industrial exhaust system, optionally downstream of a catalytic converter, using non-thermal plasma to dissociate water vapor and carbon dioxide, producing an oxygen-enriched treated airstream 22 that is mixed with the exhaust gases 24 via a mixing mechanism 20 to increase tailpipe oxygen to between about 20% and about 22% by volume, substantially matching normal atmospheric oxygen levels; (iii) a combined intake-and-exhaust configuration incorporating both modes (i) and (ii) for maximum emission reduction and combustion efficiency; and (iv) a standalone configuration in which the at least one ceramic plate 12 treats atmospheric air in an industrial, commercial, or stationary application without connection to a fuel-burning exhaust stream. The system 10 reduces EPA-regulated emissions comprising CO, NOx, HC, PM, and CO2, and the at least one ceramic plate 12 is modular, scalable, and selectable based on application requirements and environmental conditions.

### Embodiment 2: Emission Species

The system as in Embodiment 1, wherein the emissions reduced by the system 10 comprise carbon monoxide (CO), nitrogen oxides (NOx), hydrocarbons (HC), particulate matter (PM), and carbon dioxide (CO2), each regulated under applicable EPA emission standards, including but not limited to standards promulgated under the Clean Air Act, 42 U.S.C. § 7401 et seq.

### Embodiment 3: Fan Flow Rate Specification

The system as in Embodiments 1 or 2, wherein the fan 14 provides external air 16 at a volumetric flow rate of about 200 cubic feet per minute (CFM) at about 150 watts, or an equivalent flow rate selected to achieve a tailpipe oxygen content of between about 20% and about 22% by volume when the treated airflow 22 is mixed with exhaust gases 24 in exhaust-only or combined intake-and-exhaust configurations; wherein the fan 14 is optionally variable-speed and controlled by an electronic control unit (ECU) to modulate flow rate based on detected exhaust volume, emission levels, or engine load.

### Embodiment 4: Non-ozone Ceramic Plate Specification

The system as in any of Embodiments 1 through 3, wherein the non-ozone ceramic plates 12 comprise a high-dielectric ceramic material having a dielectric constant in the range of about 20 to about 30, including zirconia or equivalent high-dielectric ceramic, with titanium mesh electrodes having a work function of about 4.33 eV; wherein the non-ozone ceramic plates 12 are configured to: (a) generate coronal discharge at about 10 kV with a pulse rise time of about 10 to about 15 nanoseconds; (b) minimize formation of unwanted byproducts, including ozone, to below about 0.05 parts per million (ppm) as tunable by adjustment of voltage, pulse timing, or plate geometry; (c) reform air molecules including O2 and N2, and pollutant molecules including NOx (e.g., 2NO→N2+O2) and CO2 (e.g., CO2→CO+½O2) through non-thermal plasma-driven molecular dissociation; (d) reduce CO, HC, NOx, CO2, and PM via a combination of molecular reformation and electrostatic particle capture effects; and (e) in exhaust configurations, increase tailpipe oxygen content to between about 20% and about 22% by volume through molecular reformation and dilution with fan-supplied external air 16.

### Embodiment 5: Silicon Carbide Plate Specification

The system as in any of Embodiments 1 through 4, wherein the silicon carbide plates 12 comprise silicon carbide (SiC) having a melting point of at least about 2700 °C with titanium electrodes, configured for operation in high-temperature exhaust environments; wherein the silicon carbide plates 12 combine molecular reformation via coronal discharge at about 10 kV with mechanical and electrostatic filtration of particulate matter (PM), producing minimal byproducts tunable to below about 0.05 ppm, achieving tailpipe oxygen content of between about 20% and about 22% in exhaust configurations with a fan airflow of about 200 CFM; wherein the silicon carbide plates 12 are particularly suited for diesel vehicles or industrial systems operating in high-PM environments, such as urban settings, where simultaneous PM capture and gaseous emission reduction are required.

### Embodiment 6: Ceramic Fiber Plate Specification

The system as in any of Embodiments 1 through 5, wherein the ceramic fiber plates 12 comprise fibrous ceramic material including alumina-silica fibers thermally stable to at least about 1200 °C, with titanium electrodes; wherein the ceramic fiber plates 12 are configured to provide moderate PM capture combined with molecular reformation via coronal discharge, with byproducts tunable to below about 0.05 ppm, achieving tailpipe oxygen content of between about 20% and about 22% in exhaust configurations; wherein the ceramic fiber plates 12 are particularly suited for vehicles or systems operating in mixed suburban environments where a balance between PM capture effectiveness and molecular reformation across all pollutant species (CO, HC, NOx, CO2, PM) is desired.

### Embodiment 7: Coronal Field Generator Plate—Testing Configuration

The system as in any of Embodiments 1 through 6, further comprising at least one coronal field generator plate 12 made from a high-dielectric ceramic material having a dielectric constant of about 9 to about 10, including alumina, with stainless steel mesh electrodes having an open area of about 50% and a wire diameter of about 0.02 inches; wherein the coronal field generator plates 12 generate an enhanced coronal discharge at between about 12 kV and about 24 kV, with a pulse rise time of about 10 to about 20 nanoseconds and a pulse length of about 50 to about 200 nanoseconds, primarily for reduction of CO (via CO→CO2) and HC through enhanced non-thermal plasma treatment; wherein the coronal field generator plates 12 are best suited for temporary testing applications or specific industrial use cases where enhanced coronal discharge is the primary operational requirement, and wherein the use of coronal field generator plates in exhaust configurations may result in tailpipe oxygen levels below the target range of 20-22% due to the discharge chemistry of these plates.

### Embodiment 8: Power Supply

The system as in any of Embodiments 1 through 7, wherein the power supply 32 is selectable between: (a) a 12V DC automotive configuration comprising a 12V DC to approximately 24 kV DC high-voltage converter suitable for installation in a vehicle or mobile application; and (b) a 110V AC configuration for standalone, industrial, or stationary applications; wherein the power supply 32 delivers consistent electrical energy to drive the coronal discharge units 334 across all operational configurations, and wherein an optional electronic control unit (ECU) is incorporated to dynamically adjust at least one of: plasma discharge voltage, pulse frequency, pulse duration, and fan speed, based on detected exhaust conditions, system load, ambient temperature, or selected operational mode.

### Embodiment 9: Plate Adjustability and Scalability

The system as in any of Embodiments 1 through 8, wherein the at least one ceramic plate 12 has an adjustable size and quantity such that the intensity and coverage area of the non-thermal plasma field are scalable in proportion to: (a) the volumetric flow rate of gas to be treated; (b) the concentration of target pollutant species in the gas stream; (c) the desired level of emission reduction; and (d) the physical constraints of the installation environment; wherein individual ceramic plates 12 may have dimensions of about 4 inches by about 2 inches by about 0.5 inches as a baseline configuration, with larger or smaller plates or additional plates used to scale the system 10 for applications ranging from single-cylinder small engines to large industrial exhaust systems, without requiring thermal plasma, combustion-based treatment, or catalytic precious-metal materials.

### Embodiment 10: Mixing Mechanism

The system as in any of Embodiments 1 through 9, wherein in exhaust-only or combined intake-and-exhaust configurations the system 10 further comprises a mixing mechanism 20 configured to combine the treated airstream 22 output from the coronal discharge unit with exhaust gases 24 from an engine 26 or industrial exhaust source; wherein the mixing mechanism 20 comprises a Y-pipe junction, a venturi mixing tube, or an equivalent fluid mixing structure configured to create turbulent mixing of the treated airstream 22 with the exhaust gases 24 prior to discharge at a tailpipe area 28; and wherein the mixing mechanism 20 is positioned downstream of the coronal discharge unit and, in engine applications, optionally downstream of a catalytic converter, to produce an oxygen-enriched combined exhaust stream having an oxygen content of between about 20% and about 22% by volume at a temperature at or below ambient temperature.

### Embodiment 11: Sealing Ring—Pressurized Environments

The system as in any of Embodiments 1 through 10, further comprising a sealing ring or pressurization seal disposed about the housing of the coronal discharge unit and configured to maintain a positive air pressure differential within the housing relative to the surrounding environment; wherein the sealing ring is configured for use in environments classified as hazardous locations under OSHA regulations, including but not limited to: paint booths, welding environments, and enclosed garages containing flammable gases, vapors, or combustible materials; wherein the sealing ring prevents ingress of ambient flammable gases into the plasma generation zone and maintains internal air pressurization sufficient to prevent reverse flow; and wherein all electrical components within the pressurized housing are rated for use in the applicable hazard classification, including Class 1, Division 2 environments as defined under OSHA Section 1910.307 and applicable NFPA standards.

### Embodiment 12: Plate Electrode Configuration

The system as in any of Embodiments 1 through 11, wherein the ceramic plates 12 within a coronal discharge unit 334 are arranged in opposing pairs, each pair comprising a first plate configured with a positive electrical charge and a second plate configured with a negative electrical charge, generating an electric field between the opposing plates sufficient to ionize gases passing therebetween and sustain the non-thermal plasma; wherein each plate 12 is optionally coated with a catalyst material including titanium dioxide (TiO2) to enhance molecular reformation reactions, and wherein the opposing-plate geometry is adjustable by varying the gap between plates to modify field intensity and plasma generation characteristics based on the application requirements.

### Embodiment 13: Air Filter Integration

The system as in any of Embodiments 1 through 12, further comprising an air filter 536 interposed between the fan 14 and the at least one ceramic plate 12 in the gas flow path, the air filter 536 configured to remove gross particulate contamination, debris, and moisture from the incoming external airstream 516 prior to its passage over or between the ceramic plates 512 for coronal discharge treatment; wherein the air filter 536 is a replaceable or washable filter element suitable for the ambient conditions of the installation environment, as shown in FIG. 6.

### Embodiment 14: Base Modular System

A modular coronal discharge system 10 for use with a fuel-burning system or industrial exhaust system, the modular system comprising: a coronal discharge unit 334 comprising a plurality of ceramic plates 312 arranged within a housing and electrically connected to an external electric power source 332, the ceramic plates 312 being configured to generate a non-thermal plasma by pulsed coronal discharge applied to gases passing through or adjacent to the ceramic plates 312; an optional fan 14 operatively associated with the coronal discharge unit 334 and configured to direct a flow of external air 16 through the non-thermal plasma field to enhance gas mixing and amplify emission reduction and oxygen-enrichment effects; wherein the modular system is selectively deployable in at least one of: (a) an intake configuration in which the coronal discharge unit 334 is applied upstream of a combustion source to ionize intake air and enhance its oxygen content for improved combustion efficiency; (b) an exhaust pipe configuration in which the coronal discharge unit 334 is applied at or near an exhaust pipe 528, optionally downstream of a catalytic converter, to dissociate water vapor and carbon dioxide in exhaust gases and produce an oxygen-enriched exhaust stream with oxygen levels increased from normal exhaust levels to between about 20% and about 22% by volume at a temperature at or below ambient temperature; or (c) a dual configuration combining both (a) and (b) for maximum emission reduction, combustion efficiency, and gas mileage improvement; and wherein the modular system reduces gaseous emissions including NOx, CO, HC, and CO2, without thermal plasma, combustion-based exhaust treatment, or precious-metal catalytic materials.

### Embodiment 15: Intake Configuration

The modular system as in Embodiment 14, wherein in the intake configuration the coronal discharge unit 334 is positioned upstream of a combustion chamber or intake manifold of an engine 26 or fuel-burning system, the unit 334 having adjustable ceramic plates 312 and optionally equipped with a fan 14 sized according to intake air volume requirements; wherein the non-thermal plasma generated by the coronal discharge unit 334 ionizes incoming air molecules to increase their oxygen reactivity and reduce contaminant concentrations including volatile organic compounds (VOCs) and particulate matter, thereby providing cleaner, oxygen-enriched air to the combustion chamber to improve combustion efficiency, reduce the formation of CO, HC, NOx, and CO2 during combustion, and increase fuel economy in internal combustion engines or enhance fuel-burning efficiency in industrial systems.

### Embodiment 16: Exhaust Pipe Configuration

The modular system as in Embodiments 14 or 15, wherein in the exhaust pipe configuration the coronal discharge unit 334 is positioned at or near an exhaust pipe 528, downstream of the combustion source and optionally downstream of a catalytic converter, the unit 334 having an array of adjustable ceramic plates 512 and optionally equipped with a fan 514 to enhance exhaust gas mixing and plasma efficiency; wherein the coronal discharge unit 334 dissociates water vapor (H2O→H2+½O2) and carbon dioxide (CO2→CO+½O2) present in the exhaust gases via non-thermal plasma, producing an oxygen-enriched treated gas stream that is mixed with exhaust gases 522 in a mixing chamber 520 to produce a combined exhaust stream at the tailpipe 528 having an oxygen content of between about 20% and about 22% by volume; wherein the non-thermal plasma absorbs or dissipates heat from the exhaust gases such that the temperature of the combined treated exhaust stream at the tailpipe 528 is maintained at or below ambient temperature without the need for external cooling apparatus; and wherein the coronal discharge unit 334 reduces all gaseous emissions regulated by EPA standards, including NOx, CO, HC, and CO2.

### Embodiment 17: Dual Configuration

The modular system as in Embodiments 14, 15, or 16, wherein in the dual configuration a first coronal discharge unit 334 is positioned upstream of the combustion source in the intake configuration and a second coronal discharge unit 334 is positioned at or near the exhaust pipe 528 in the exhaust pipe configuration, each unit 334 independently powered by the external electric power source 332; wherein the dual configuration simultaneously enhances the oxygen content of intake air to improve combustion efficiency and treats exhaust gases to reduce post-combustion emissions, achieving maximum overall reduction of CO, NOx, HC, PM, and CO2 and maximum improvement in fuel economy in engines or oxygen output in industrial systems; wherein effects at both the intake and exhaust stages are independently or simultaneously amplifiable by fans 514 associated with each respective unit 334.

### Embodiment 18: Shared Plate Set

The modular system as in any of Embodiments 14 through 17, wherein a single shared set of ceramic plates 412 serves both the intake air enhancement and exhaust gas processing functions, the shared plate set 412 being positioned and configured to treat both the intake airstream and the exhaust gas stream using a common coronal discharge unit housing 434 connected to a single power supply 432, as shown in FIG. 5; wherein the shared plate configuration reduces system cost, installation complexity, and physical footprint compared to separate intake and exhaust plate sets.

### Embodiment 19: Separate Plate Sets

The modular system as in any of Embodiments 14 through 18, wherein a first set of ceramic plates 512 is dedicated to intake air enhancement and positioned upstream of the combustion source, and a second, separate set of ceramic plates 512 is dedicated to exhaust gas processing and positioned at or near the exhaust pipe 528; wherein each set of ceramic plates 512 is independently sized, configured, and powered to optimize performance for its respective gas stream, and wherein the first and second sets may be of differing plate compositions, sizes, and quantities selected to address the differing gas composition, temperature, and flow rate characteristics of intake air versus exhaust gas.

### Embodiment 20: Plate Size and Quantity Adjustability

The modular system as in any of Embodiments 14 through 19, wherein ceramic plate sizes and quantities within each coronal discharge unit 334 are adjustable and configurable by the installer or operator to scale the non-thermal plasma field intensity in proportion to the volume of gas to be treated, the concentration of target pollutant species, and the desired emission reduction level; wherein the adjustability of plate sizes and quantities allows the modular system to be configured for applications ranging from single-cylinder small engines and light-duty passenger vehicles to large-displacement diesel engines and industrial exhaust systems having high exhaust volumetric flow rates, without requiring fundamental redesign of the coronal discharge unit 334.

### Embodiment 21: Thermal Management—Ambient Temperature Maintenance

The modular system as in any of Embodiments 14 through 20, wherein in the exhaust pipe configuration the coronal discharge unit 334 maintains an exhaust exit temperature at or below ambient temperature levels through heat absorption and dissipation by the non-thermal plasma and optionally by the flow of fan-supplied external air 16 through the mixing chamber 520; wherein no external heat exchanger, coolant circuit, or active cooling system is required to achieve ambient-temperature exhaust output; and wherein the cooling effect is an intrinsic consequence of the non-thermal plasma process and the dilution of hot exhaust gases 24 with cooler fan-supplied external air 22 at approximately 20-50 °C.

### Embodiment 22: Ecu and Control System

The modular system as in any of Embodiments 14 through 21, further comprising an electronic control unit (ECU) operatively connected to the external electric power source 332 and optionally to the fan 514, the ECU configured to: (a) monitor at least one operational parameter selected from the group consisting of exhaust gas temperature, exhaust gas flow rate, detected pollutant concentration, ambient air temperature, and engine load; (b) dynamically adjust at least one of: plasma discharge voltage, pulse frequency, pulse duration, and fan 514 speed in response to the monitored operational parameters to optimize emission reduction performance and energy consumption; and (c) switch between operational modes including intake-only, exhaust-only, dual, and standby based on detected system conditions or user input.

### Embodiment 23: Dual-exhaust System Configurations

The modular system as in any of Embodiments 14 through 22, wherein the system is configured for use with a dual-exhaust engine or industrial system having two or more separate exhaust pipes, as shown in FIG. 1 and FIG. 3; wherein the modular system comprises at least two coronal discharge units 334, one associated with each exhaust pipe, each unit 334 independently powered and equipped with a fan 514 and mixing chamber 520 configured to deliver an oxygen-enriched treated exhaust stream at between about 20% and about 22% O2 by volume from each respective exhaust pipe; and wherein the dual-exhaust configuration may employ a single shared external power supply 32 or individual power supplies for each coronal discharge unit 334.

### Embodiment 24: Base Method—All Modes

A method for reducing emissions and enhancing combustion using coronal discharge, the method comprising: providing a flow of external air 16 via a fan 14 at a flow rate sufficient to support molecular reformation and, in exhaust configurations, to achieve a combined tailpipe oxygen content of between about 20% and about 22% by volume; passing the external air 16 over or between at least one ceramic plate 12 selected from the group consisting of non-ozone ceramic plates, silicon carbide plates, ceramic fiber plates, and combinations thereof, the at least one ceramic plate 12 housed in a coronal discharge unit 334; applying electrical power from a power supply 32 to the at least one ceramic plate 12 to generate a coronal discharge and produce a non-thermal plasma at the surface of the at least one ceramic plate 12, the non-thermal plasma reforming air molecules in the gas stream passing through the coronal discharge unit 334 without relying on catalytic layers, precious-metal catalysts, or hydrogen production for fuel cell applications; selecting an operational configuration for the system from the group consisting of: intake-only, exhaust-only, combined intake-and-exhaust, and standalone; and wherein the method reduces EPA-regulated emissions comprising CO, NOx, HC, PM, and CO2; and in exhaust-only or combined intake-and-exhaust configurations, the method further comprises mixing treated airstream 22 output from the coronal discharge unit with exhaust gases 24 using a mixing mechanism 20 to increase tailpipe oxygen to between about 20% and about 22% by volume, substantially matching normal atmospheric oxygen levels.

### Embodiment 25: Fan Amplification Step

The method as in Embodiment 24, further comprising amplifying the effects of the coronal discharge by operating the fan 14 or 514 to direct a continuous flow of external air 16 through the non-thermal plasma field within the coronal discharge unit 334, thereby enhancing gas mixing, increasing plasma-molecule contact time, and amplifying the volumetric contribution of oxygen-enriched treated air to the combined exhaust stream at the tailpipe 28 or 528.

### Embodiment 26: Intake Mode Method

The method as in Embodiments 24 or 25, wherein in the intake-only or combined intake-and-exhaust configuration, the method further comprises: positioning the coronal discharge unit 334 upstream of a combustion chamber or intake manifold of an engine 26 or fuel-burning system; directing the non-thermal plasma to ionize incoming air molecules and increase their reactive oxygen content; reducing concentrations of contaminants including volatile organic compounds (VOCs) and particulate matter in the intake air prior to combustion; and supplying the oxygen-enriched, contaminant-reduced intake air to the combustion chamber to improve combustion completeness, reduce the production of CO, HC, NOx, and CO2 during the combustion process, and increase fuel economy in internal combustion engines or enhance fuel-burning efficiency in industrial systems.

### Embodiment 27: Exhaust Pipe Mode Method

The method as in any of Embodiments 24 through 26, wherein in the exhaust-only or combined intake-and-exhaust configuration, the method further comprises: positioning the coronal discharge unit 334 at or near the exhaust pipe 528, optionally downstream of a catalytic converter in engine applications; applying the non-thermal plasma to exhaust gases entering the coronal discharge unit 334 to dissociate water vapor (H2O→H2+½O2) and carbon dioxide (CO2→CO+½O2) present in the exhaust stream; producing an oxygen-enriched treated gas stream having an increased oxygen content relative to untreated exhaust; mixing the treated gas stream with exhaust gases 522 in a mixing chamber 520 via a Y-pipe or equivalent mixing junction to produce a combined exhaust stream at the tailpipe 528 having an oxygen content of between about 20% and about 22% by volume, substantially matching normal atmospheric oxygen levels; and maintaining the temperature of the combined exhaust stream at or below ambient temperature through heat absorption and dissipation by the non-thermal plasma and optional fan-supplied air dilution, without external cooling apparatus.

### Embodiment 28: Dual Mode Method

The method as in any of Embodiments 24 through 27, wherein in the combined intake-and-exhaust configuration, the method simultaneously performs: (a) the intake mode steps of Embodiment 26 using a first coronal discharge unit 334 or a first portion of a shared plate set 412; and (b) the exhaust pipe mode steps of Embodiment 27 using a second coronal discharge unit 334 or a second portion of the shared plate set 412; wherein the combined performance of intake air enhancement and exhaust gas treatment achieves maximum overall reduction of CO, NOx, HC, PM, and CO2 emissions and maximum improvement in fuel economy or oxygen output relative to single-mode operation.

### Embodiment 29: Plate Selection Step

The method as in any of Embodiments 24 through 28, further comprising selecting the composition of the at least one ceramic plate 12 based on the application environment and target pollutant profile, according to the following guidelines: (a) selecting non-ozone ceramic plates for gasoline vehicle applications in rural or low-PM environments where comprehensive gaseous emission reduction (CO, HC, NOx, CO2) with minimal byproduct formation is the primary objective; (b) selecting silicon carbide plates for diesel vehicle or industrial applications in high-PM urban environments where simultaneous PM capture and gaseous emission reduction are required; (c) selecting ceramic fiber plates for mixed suburban environments where a balance of PM capture and gaseous emission reduction is desired; and (d) selecting coronal field generator plates for temporary testing or specific applications where enhanced coronal discharge for CO and HC reduction is the primary objective, with the understanding that tailpipe O2 may fall below the 20-22% target range in exhaust configurations.

### Embodiment 30: Plate Sizing and Adjustment Step

The method as in any of Embodiments 24 through 29, further comprising adjusting at least one of the size, quantity, spacing, and composition of the at least one ceramic plate 12 prior to or during operation to modulate the intensity and spatial coverage of the non-thermal plasma field in proportion to: (a) the volumetric flow rate of the gas stream to be treated; (b) the concentration of target pollutant species in the gas stream; (c) the desired percentage reduction in each regulated emission species; and (d) the physical dimensions and configuration of the installation environment, including the exhaust pipe diameter, intake manifold dimensions, and available mounting space.

### Embodiment 31: Standalone Atmospheric Treatment Method

The method as in any of Embodiments 24 through 30, wherein in the standalone configuration the method further comprises: positioning the coronal discharge unit 334 in a fixed, stationary, or portable installation not connected to an engine exhaust stream; drawing ambient atmospheric air through the coronal discharge unit 334 using the fan 14; applying non-thermal plasma via the at least one ceramic plate 12 to the ambient air to reduce concentrations of airborne pollutants including VOCs, PM, NOx, and CO present in the atmospheric air; and discharging the treated air into the surrounding environment, for applications including but not limited to industrial facility air quality improvement, commercial building air purification, and ambient air quality remediation in high-pollution urban environments.

What is claimed is:

1. A system for reducing emissions and enhancing combustion, the system comprising:
a fan configured to provide a flow of external air;
at least one ceramic plate over which the external air passes, the at least one ceramic plate being selected from the group consisting of non-ozone ceramic plates, silicon carbide plates, ceramic fiber plates, and combinations thereof;
a power supply electrically connected to the at least one ceramic plate and configured to generate coronal discharge on the at least one ceramic plate sufficient to reform air molecules via non-thermal plasma without relying on catalytic layers or producing hydrogen for fuel cell applications; and
a housing configurable in at least one of: (i) an intake-only configuration in which the at least one ceramic plate is positioned upstream of a combustion air intake to enhance oxygen content of intake air and improve combustion efficiency; (ii) an exhaust-only configuration in which the at least one ceramic plate is positioned at or near an exhaust pipe to treat exhaust gases and increase tailpipe oxygen to between about 20% and about 22% by volume; (iii) a combined intake-and-exhaust configuration combining features of (i) and (ii); and (iv) a standalone configuration for treating atmospheric air in industrial or stationary applications.

2. The system of claim 1, wherein the system reduces emissions comprising CO, NOx, HC, PM, and CO2 to levels compliant with EPA-regulated standards.

3. The system of claim 1, further comprising a mixing mechanism configured to combine treated air output from the at least one ceramic plate with exhaust gases, wherein the mixing mechanism is a Y-pipe or equivalent junction configured to direct the combined mixture to a tailpipe.

4. The system of claim 1, wherein the non-ozone ceramic plates comprise a high-dielectric ceramic material having a dielectric constant in the range of about 20 to about 30, and wherein electrodes associated with the non-ozone ceramic plates comprise titanium mesh having a work function of about 4.33 eV, configured to minimize byproduct formation to below about 0.05 ppm.

5. The system of claim 1, wherein the silicon carbide plates comprise a material having a melting point of at least about 2700 °C and are configured to combine molecular reformation with particulate matter filtration, making the silicon carbide plates particularly suitable for diesel vehicles operating in high-PM emission environments.

6. The system of claim 1, wherein the ceramic fiber plates comprise alumina-silica fibers thermally stable to at least about 1200 °C with titanium electrodes, configured to provide moderate particulate matter capture balanced with molecular reformation across CO, HC, NOx, CO2, and PM pollutants.

7. The system of claim 1, further comprising a coronal field generator plate comprising a high-dielectric ceramic material having a dielectric constant of about 9 to about 10 and stainless steel mesh electrodes, configured to effect enhanced coronal discharge at 12-24 kV with a pulse rise time of 10-20 ns and pulse length of 50-200 ns, particularly suited for temporary testing or CO and HC reduction applications.

8. The system of claim 1, wherein in the exhaust-only configuration, the non-thermal plasma absorbs or dissipates heat from the exhaust gases such that an exit temperature of treated exhaust is maintained at or below ambient temperature without external cooling apparatus.

9. The system of claim 1, further comprising an electronic control unit (ECU) configured to dynamically adjust at least one of: plasma discharge intensity, fan speed, and plate spacing, based on detected exhaust conditions, system load, or selected operational configuration.

10. The system of claim 1, wherein the combined intake-and-exhaust configuration employs a single shared set of ceramic plates serving both intake air enhancement and exhaust gas processing functions.

11. The system of claim 1, wherein the combined intake-and-exhaust configuration employs a first set of ceramic plates for intake air enhancement positioned upstream of a combustion source, and a second set of ceramic plates for exhaust gas processing positioned at or near the exhaust pipe, downstream of a catalytic converter when one is present in the exhaust system, or directly at the exhaust pipe in vehicles or systems not equipped with a catalytic converter.

12. A method for reducing emissions and enhancing combustion using coronal discharge, the method comprising:
providing a flow of external air via a fan;
passing the external air over at least one ceramic plate selected from the group consisting of non-ozone ceramic plates, silicon carbide plates, ceramic fiber plates, and combinations thereof;
applying a power supply to the at least one ceramic plate to perform coronal discharge and generate non-thermal plasma sufficient to reform air molecules, thereby reducing CO, NOx, HC, PM, and CO2 emissions without catalytic layers or hydrogen production for fuel cell applications;
selecting a configuration from the group consisting of: intake-only, exhaust-only, combined intake-and-exhaust, and standalone; and
in exhaust-only or combined intake-and-exhaust configurations, mixing treated air output with exhaust gases to increase tailpipe oxygen to between about 20% and about 22% by volume, substantially matching normal atmospheric oxygen levels.

13. The method of claim 12, wherein applying coronal discharge to intake air ionizes the intake air to enhance its oxygen content upstream of a combustion chamber, improving combustion efficiency and increasing fuel economy in an internal combustion engine or enhancing fuel-burning processes in industrial systems.

14. The method of claim 12, wherein applying coronal discharge at the exhaust pipe dissociates water vapor and carbon dioxide present in exhaust gases, producing an oxygen-enriched exhaust stream at a temperature equal to or below ambient temperature without external cooling, while reducing NOx, CO, HC, and CO2 in compliance with EPA-regulated emission standards.

15. The method of claim 12, further comprising adjusting at least one of the size, quantity, and composition of the at least one ceramic plate to modulate plasma field intensity in proportion to a desired level of emission reduction for a given fuel-burning or industrial exhaust system.

16. A modular coronal discharge system for use with a fuel-burning system or industrial exhaust system, the modular system comprising:
a coronal discharge unit comprising a plurality of ceramic plates arranged in a housing and electrically connected to an external power source, the ceramic plates configured to generate non-thermal plasma by pulsed coronal discharge for molecular reformation of gases passing therethrough;
an optional fan associated with the coronal discharge unit to enhance gas flow through the non-thermal plasma field and amplify emission reduction effects; and
wherein the modular system is selectively deployable to: (a) ionize intake air upstream of a combustion source to enhance oxygen content and improve combustion efficiency; (b) process exhaust gases at an exhaust pipe, optionally downstream of a catalytic converter, to produce an oxygen-enriched exhaust with oxygen levels increased from normal exhaust levels to about 20-22% by volume at a temperature at or below ambient; or (c) both (a) and (b) simultaneously; without thermal plasma, combustion-based exhaust treatment, or catalytic precious-metal materials.

17. The modular system of claim 16, wherein plate sizes and quantities of the plurality of ceramic plates are adjustable to configure the plasma field intensity to accommodate varying exhaust flow rates, system sizes, and emission reduction targets.

18. The modular system of claim 16, wherein a single shared set of ceramic plates is employed for both intake air enhancement and exhaust gas processing.

19. The modular system of claim 16, wherein a first set of ceramic plates is positioned upstream of a combustion source for intake air enhancement and a second, separate set of ceramic plates is positioned at or near the exhaust pipe for exhaust gas processing, each set independently powered by the external power source.

20. The modular system of claim 16, further comprising an air filter interposed between the fan and the ceramic plates to remove gross particulate contamination from the incoming air stream prior to coronal discharge treatment.
